(19) United States
(12) Patent Application Publication
(10) Pub. No.: US 2012/0304837 A1
(43) Pub. Date: Dec. 6, 2012

(54) SCREWDRIVER

(75) Inventor: YAN ZHUANG, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/215,678

(22) Filed: Aug. 23, 2011

(30) Foreign Application Priority Data
Jun. 3, 2011 (CN) 201110148531.1

(51) Int. Cl. B25B 23/10

(52) U.S. Cl. 81/452

(57) ABSTRACT

A screwdriver for screwing a screw includes a handle, a shaft protruding from the handle, a tip protruding a distal end of the shaft, a nut threaded on the shaft, a jaw slidably mounted on the shaft. The jaw includes a main body and a plurality of flexible holding elements protruding from the main body. The flexible holding elements define a flexible holding space. The screwdriver further includes a spring retained between the nut and the jaw. The bendable portions hold the screw; as the screw is screwed, the main body is withdrawn along the shaft to compress the spring.

### BACKGROUND

1. Technical Field

This disclosure relates to screwdrivers, particularly to a screwdriver with a jaw.

2. Description of Related Art

A screwdriver is a tool for screwing screws and rotating other machine elements with the mating drive system. A typical hand screwdriver includes an approximately cylindrical handle of a size and shape to be held by a human hand, and an axial shaft fixed to the handle, the tip of which is shaped to fit a particular type of screw. In use, the user holds the screw by hand, the tip engages the screw, and the handle and the shaft are then rotated to apply torque to the tip so the screw is screwed. However, some screws are very small and are awkward to hold by hand. Some screwdriver tips are magnetic, so that the screw attaches to the screwdriver without requiring the user to manually hold the screw. This is particularly useful with small screws, but it is difficult to steadily attach the screw.

Therefore, there is a room for improved in the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the exemplary screwdriver. Moreover, in the drawings like reference numerals designate their respective parts throughout the several views. Wherever possible, the same reference numbers are used throughout the drawings to refer to the same or like elements of an embodiment.

FIG. 1 is a schematic view of an exemplary embodiment of a screwdriver.

FIG. 2 is an exploded view of the screwdriver of FIG. 1.

### DETAILED DESCRIPTION

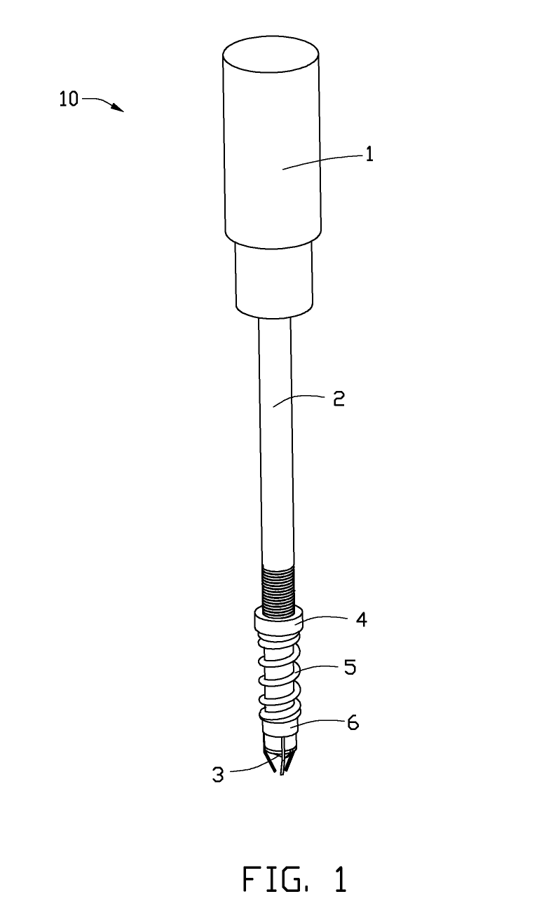

Referring to FIG. 1, an exemplary embodiment of a screwdriver 10 includes a handle 1, a shaft 2, a tip 3, a nut 4, a spring 5 and a jaw 6. The nut 4, the spring 5 and the jaw 6 are mounted on the shaft 2 in turn, and one end of the spring 5 is fastened (e.g., soldered) on the nut 4, the other end of the spring 5 is fastened (e.g., soldered) on the jaw 6.

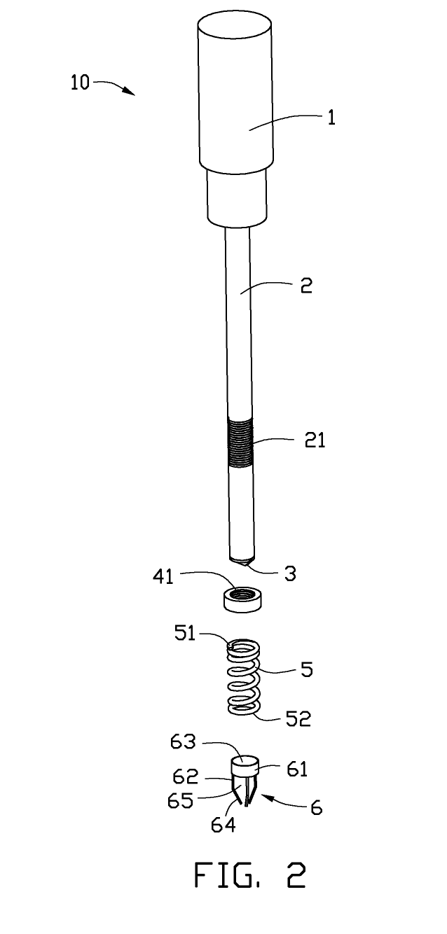

Referring to FIG. 2, the shaft 2 protrudes from one end of the handle 1, and the tip 3 protrudes from a distal end of the shaft 2. The shaft 2 is substantially cylindrical with an external screw thread 21. The tip 3 includes any drive head, e.g., Phillips, straight-tip, hex, etc.

The nut 4 has an internal screw thread 41 to be fitted onto the external screw thread 21 of the shaft 2. The nut 4 can slide along the shaft 2 when rotated relative to the shaft 2.

The spring 5 may be a compressed spring, including a first end 51 and a second end 52. The first end 51 is soldered to the nut 4. The spring 5 is wound around the shaft 2 when the nut 4 is screwed on the shaft 2.

The jaw 6 includes a main body 61 and a plurality of flexible holding elements 62 protruding from the main body 61. In this exemplary embodiment, three flexible holding elements 62 protrude from the main body 61. The main body 61 is hollow and defines an opening 63. The flexible holding elements 62 surround the opening 63 and define a flexible holding space 65. Each flexible holding element 62 has a bendable portion 64 bent toward the flexible holding space 65 for receiving and retaining the head of a screw. The main body 61 can be soldered to the second end 52 of the spring 5 and mounted on the shaft 2 so the jaw 6 is retained on the shaft 2. The tip 3 is accommodated in the flexible holding space 65 when the jaw 6 is retained on the shaft 2. Additionally, the opening 63 is larger than the shaft 2 so the main body 61 can slide relative to the shaft 2 when the main body 61 is mounted on the shaft 2.

In use, a screw head is retained in the flexible holding space 65 and engages the tip 3. At this time, the screw is held by the bendable portions 64 so the screw is steadily attached on the screwdriver 10, thereby the user avoids holding the screw manually when the screw is being screwed. As the screw is screwed, the main body 61 is drawn along the shaft 2 towards the handle to compress the spring 5 while the portions 64 are brought closer to tip 3 to the point where tip 3 begins to spread apart portions 64 to allow the separation of the screwdriver and the screw being driven. After the screw is screwed, the spring 5 drives the main body 61 to restore to its original state.

It is to be further understood that even though numerous characteristics and advantages of the exemplary embodiments have been set forth in the foregoing description, together with details of structures and functions of various embodiments, the disclosure is illustrative only, and changes may be made in detail, especially in matters of shape, size, and arrangement of parts within the principles of the exemplary invention to the full extent indicated by the broad general meaning of the terms in which the appended claims are expressed.

What is claimed is:

1. A screwdriver comprising:
a handle;
a shaft protruding from the handle;
a tip protruding from a distal end of the shaft;
a nut screwed on the shaft;
a jaw slidably mounted on the shaft, the jaw comprising a main body and a plurality of flexible holding elements protruding from the main body, the flexible holding elements defining a flexible holding space;
a spring retained between the nut and the jaw;
wherein the tip is accommodated in the flexible holding space.

2. The screwdriver of claim 1, wherein the shaft is substantially cylindrical with an external screw thread; the nut has an internal screw thread to be fitted onto the external screw thread of the shaft.

3. The screwdriver of claim 1, wherein the spring includes a first end and a second end; the first end is welded to the nut, the second end is welded to the main body.

4. The screwdriver of claim 1, wherein there are three flexible holding elements protruding from the main body.

5. The screwdriver of claim 1, wherein the main body is hollow and defines an opening; the opening is larger than the shaft so the main body is capable of sliding relative to the shaft when the main body is mounted on the shaft.

6. The screwdriver of claim 1, wherein each flexible holding element has a bending portion bent toward the flexible holding space.

7. The screwdriver of claim 1, wherein turning the screwdriver to drive a screw causes that holding element to move up the shaft and the tip to spread apart the bending portions.

8. A screwdriver for driving a screw, the screwdriver comprising:
a handle;
a shaft protruding from the handle;
a tip protruding from a distal end of the shaft;
a nut screwed on the shaft;
a jaw slidably mounted on the shaft, the jaw comprising a main body and a plurality of flexible holding elements protruding from the main body, the flexible holding elements defining a flexible holding space;
a spring retained between the nut and the jaw;
wherein the screw is held by the bending portions; as the screw is driven, the main body is withdrawn along the shaft to compress the spring.

9. The screwdriver of claim 8, wherein the shaft is substantially cylindrical with an external screw thread; the nut has an internal screw thread to be fitted onto the external screw thread of the shaft.

10. The screwdriver of claim 8, wherein the spring includes a first end and a second end; the first end is welded to the nut, the second end is welded to the main body.

11. The screwdriver of claim 8, wherein there are three flexible holding elements protruding from the main body.

12. The screwdriver of claim 8, wherein the main body is hollow and defines an opening; the opening is larger than the shaft so the main body is capable of sliding relative to the shaft when the main body is mounted on the shaft.

13. The screwdriver of claim 8, wherein each flexible holding element has a bending portion bent toward the flexible holding space.

14. The screwdriver of claim 13, wherein turning the screwdriver to drive a screw causes that holding element to move up the shaft and the tip to spread apart the bending portions.
